(19) United States
(12) Patent Application Publication
(10) Pub. No.: US 2026/0145725 A1
(43) Pub. Date: May 28, 2026

(54) METHOD AND APPARATUS FOR HANDS ON/OFF DETECTION BASED ON AN ANTENNA

(71) Applicants: HYUNDAI MOTOR COMPANY, Seoul (KR); KIA CORPORATION, Seoul (KR)

(72) Inventors: Jae Kyu Yu, Hwaseong-si (KR); Dae Han Choi, Hwaseong-si (KR); Young Man Kim, Hwaseong-si (KR); Young Seok Jeon, Hwaseong-si (KR)

(73) Assignees: HYUNDAI MOTOR COMPANY, Seoul (KR); KIA CORPORATION, Seoul (KR)

(21) Appl. No.: 19/255,381

(22) Filed: Jun. 30, 2025

(30) Foreign Application Priority Data
Nov. 25, 2024 (KR) 10-2024-0169234

(51) Int. Cl. B62D 1/06; B62D 15/00; G01D 5/14

(52) U.S. Cl. CPC B62D 1/06; B62D 15/00; G01D 5/14

(57) ABSTRACT

A method for detecting a hands on/off detection state of a steering wheel of a vehicle includes: measuring a signal from one or more antenna radiators disposed inside the steering wheel of the vehicle; and determining the hands on/off state of the steering wheel, based on a score determined based on the signal.

### CROSS-REFERENCE TO RELATED APPLICATION

The present application claims the benefit of and priority to Korean Patent Application No. 10-2024-0169234, filed on Nov. 25, 2024, the entire contents of which are incorporated herein by reference.

### TECHNICAL FIELD

The present disclosure relates to a method and an apparatus hands on/off detection based on an antenna.

### BACKGROUND

The statements in this section merely provide background information related to the present disclosure and do not necessarily constitute prior art.

As autonomous driving functions and safety techniques of vehicles have been developed, a technique for detecting on a real-time basis whether a driver properly holds a steering wheel to control the vehicle becomes more important. Accordingly, various sensors are applied to detect hands on/off (HOD) state. Representative hands on/off detection techniques include capacitive sensors, torque sensors, and pressure sensors.

The capacitive sensor is a method for detecting a change in charge on a surface of the steering wheel to determine the hands on/off state. The hands on/off detection technique based on capacitive sensor has the following limitations. When a driver wears gloves or in a low humidity situation, detection accuracy may become poor. In addition, a contact state may not be properly recognized based on a position or a minute movement of hands, thereby resulting in poor accuracy.

Torque sensor is a method for determining the hands on/off state, based on a rotation force, i.e., a torque applied to the steering wheel. The on/off detection technique based on the torque sensor has the following limitations. Even though the driver holds the steering wheel while a vehicle is driven straight, no significant force may be applied to the steering wheel. Consequently, this case may be determined as the hands off state.

The pressure sensor is a method of determining the hands on/off state by detecting a pressure applied to the steering wheel. The hands on/off detection technique based on the pressure sensor has the following limitations. Even though the driver holds the steering wheel, when the pressure applied to the steering wheel is lower than a reference pressure, this case may be incorrectly determined as the hands off state.

Therefore, there is a demand for a technique for a method and an apparatus, which can more accurately detect a hands on/off state of a driver.

### SUMMARY

The present disclosure mainly aims to provide a method and an apparatus for hands on/off detection based on an antenna. Specifically, the present disclosure mainly aims to provide a method and an apparatus for more accurate and precise hands on/off detection by embedding an antenna radiator in a steering wheel and detecting hands on/off of a driver, based on a signal received from the antenna radiator.

The technical objects of the present disclosure are not limited to those described above, and other technical objects not mentioned above may be understood clearly by those having ordinary skill in the art from the descriptions given below.

An embodiment of the present disclosure provides a method for detecting a hands on/off state of a steering wheel of a vehicle. The method includes measuring a signal from one or more antenna radiators disposed inside the steering wheel of the vehicle; and determining the hands on/off state of the steering wheel, based on a score determined based on the signal.

Another embodiment of the present disclosure provides an apparatus for detecting a hands on/off state of a steering wheel of a vehicle. The apparatus includes one or more antenna radiators disposed inside the steering wheel of the vehicle; a receiver configured to detect a change in the radiator; and a control unit configured to determine the hands on/off state of the steering wheel, based on a signal measured by using the receiver.

According to one embodiment of the present disclosure, an antenna radiator is disposed along a circumference of a steering wheel, and a hands on/off state is determined, based on a signal received from the antenna radiator. In this manner, the hands on/off state may be more precisely determined than a technique of determining the hands on/off state, based on a capacitive sensor.

According to one embodiment of the present disclosure, an antenna radiator is disposed along a circumference of a steering wheel, and a hands on/off state is determined, based on a signal received from the antenna radiator. In this manner, the hands on/off state may be more accurately determined during straight driving than a technique of determining the hands on/off state, based on a torque sensor.

According to one embodiment of the present disclosure, one or more antenna radiators are disposed along a circumference of a steering wheel, and a hands off state is determined in a section where each of the antenna radiator is disposed, based on a score calculated for each of the antenna radiators. In this manner, a hands on/off state may be determined for each section of the steering wheel. Furthermore, it may be determined whether a user holding the steering wheel with any hand of a left hand and a right hand. As a result, the hands on/off state may be more precisely determined compared to the related art.

The technical effects of the present disclosure are not limited to the technical effects described above, and other technical effects not mentioned herein may be understood to those having ordinary skill in the art to which the present disclosure belongs from the description below.

### BRIEF DESCRIPTION OF THE DRAWINGS

FIG. 1 is a block diagram schematically illustrating an apparatus for hands on/off detection based on an antenna according to one embodiment of the present disclosure.

FIG. 2A is an example diagram of a steering wheel in which an antenna radiator according to one embodiment of the present disclosure is incorporated.

FIG. 2B is an example diagram of a steering wheel in which one or more antenna radiators according to one embodiment of the present disclosure are incorporated across a plurality of sections.

FIG. 3A is a diagram for describing a graph illustrating a signal measured by the antenna radiator according to one embodiment of the present disclosure.

FIG. 3B is a diagram for describing a graph illustrating signals measured by one or more antenna radiators according to one embodiment of the present disclosure.

FIG. 4 is a flowchart schematically illustrating a method for hands on/off detection based on an antenna radiator according to one embodiment of the present disclosure.

FIG. 5 is a block diagram schematically illustrating a computing device, which may be used to implement an apparatus and a method described in the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms, such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is meant to further include other components, not to exclude thereof unless specifically stated to the contrary. The terms, such as ‘unit’, ‘module’, and the like, refer to one or more units for processing at least one function or operation, which may be implemented by hardware, software, or a combination thereof. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function.

Each controller, module, unit, component, device, element, and the like may separately embody or be included with a processor and a memory, such as a non-transitory computer readable media, as part of the apparatus.

The following detailed description, together with the accompanying drawings, is intended to describe embodiments of the present disclosure and is not intended to represent the only embodiments in which the present disclosure may be practiced.

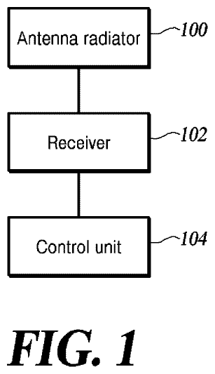

FIG. 1 is a block diagram schematically illustrating an apparatus for hands on/off detection based on an antenna according to one embodiment of the present disclosure.

Referring to FIG. 1, the apparatus for hands on/off detection based on the antenna according to one embodiment of the present disclosure may include an antenna radiator 100, a receiver 102, and a control unit 104.

The antenna radiator 100 may be installed inside a steering wheel of a vehicle. When a user holds the steering wheel with his or her hand, an electromagnetic signal of the antenna radiator 100 and a resonant frequency of the electromagnetic signal may be changed. The electromagnetic signal may be a return loss signal. The antenna radiator 100 may be implemented as a loop antenna type made of a conductive material.

The receiver 102 may measure the electromagnetic signal received from the antenna radiator 100. The receiver 102 may transmit the measured electromagnetic signal to the control unit 104.

The control unit 104 may determine a hands on/off state of the steering wheel, based on the electromagnetic signal received from the receiver 102. In other words, the control unit 104 may determine whether the user holds the steering wheel with his or her hands, based on the electromagnetic signal. In other words, the control unit 104 may detect whether the user holds the steering wheel, based on the electromagnetic signal.

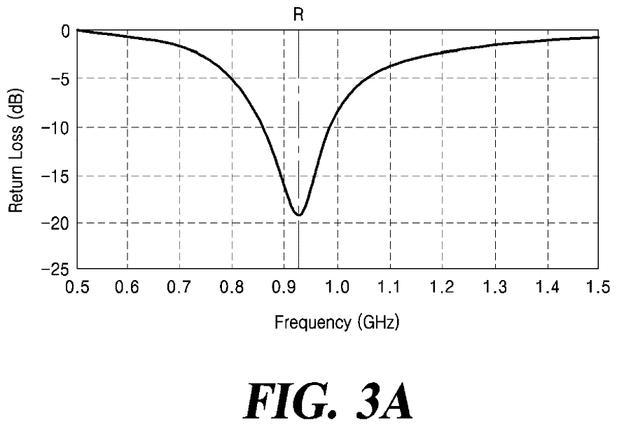

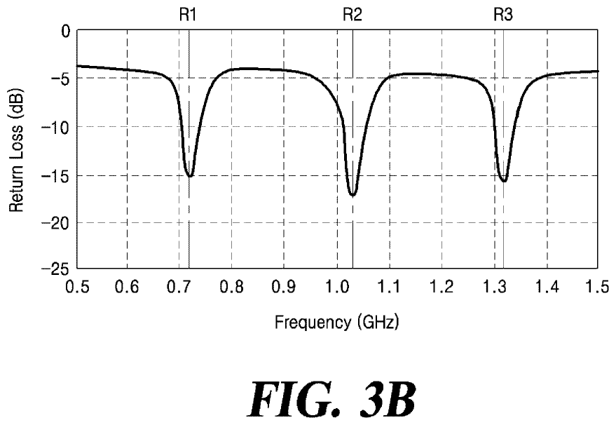

The control unit 104 may determine the hands on/off state of the steering wheel, based on a score determined by the electromagnetic signal. For example, the control unit 104 may determine a hands off state when the score is equal to or greater than a threshold value. A size of the score may be determined, based on whether the resonant frequency of the electromagnetic signal falls within a reference range. The resonant frequency, the reference range, and the score of the electromagnetic signal are described in more detail below with reference to FIG. 3A.

The control unit 104 may be implemented by using one or more computing devices 50. The control unit 104 may include at least one memory 500 and at least one processor 520.

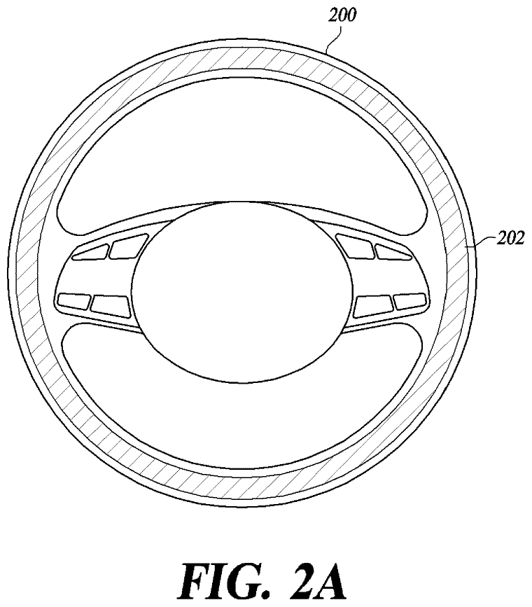

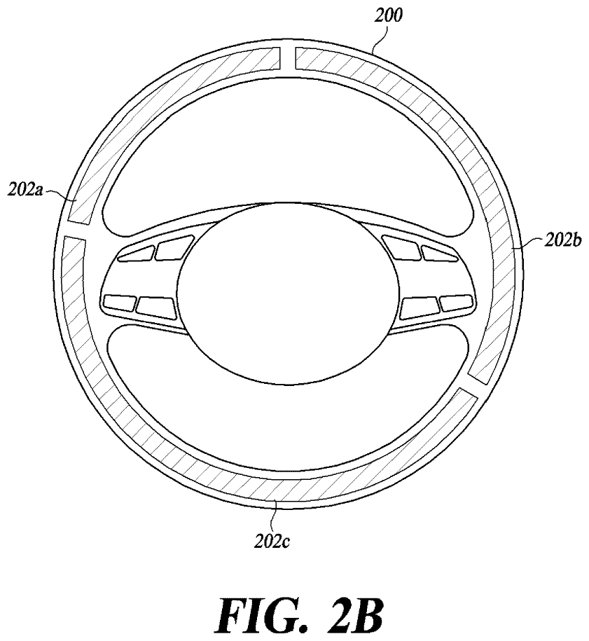

FIG. 2A is an example diagram of a steering wheel in which an antenna radiator according to one embodiment of the present disclosure is incorporated.

Referring to FIG. 2A, a steering wheel 200 according to one embodiment of the present disclosure may include an antenna radiator 202. In other words, the antenna radiator 202 may be disposed inside the steering wheel 200. The antenna radiator 202 may be disposed along a circumference of the steering wheel.

FIG. 2B is an example diagram of a steering wheel in which one or more antenna radiators according to one embodiment of the present disclosure are incorporated across a plurality of sections.

Referring to FIG. 3B, the steering wheel 200 according to an embodiment of the present disclosure may include a plurality of antenna radiators 202a, 202b, and 202c. Each of the plurality of antenna radiators 202a, 202b, and 202c may be disposed over a plurality of sections along the circumference of the steering wheel. Each of the plurality of antenna radiators 202a, 202b, and 202c may have a different size. When the plurality of antenna radiators is provided, a score may be separately calculated for each of the antenna radiators, and a reference range may be differently set for each of the antenna radiators. The number of scores and the number of reference ranges may be the same as the number of antenna radiators. The reference range and the score in a case where the plurality of antenna radiators is provided are described in more detail below with reference to FIG. 3B.

FIG. 3A is a diagram for describing a graph illustrating a signal measured by the antenna radiator according to one embodiment of the present disclosure.

Referring to FIG. 3A, a graph illustrating an electromagnetic signal measured by the antenna radiator is illustrated. An x-axis of the graph represents a frequency. A y-axis of the graph represents a return loss. A unit of the frequency may be gigahertz (GHz) or megahertz (MHz). A unit of the return loss may be decibel (dB). In other words, the graph may be a plot illustrating the return loss of the electromagnetic signal as a function of the frequency.

The control unit 104 may store in advance a reference value for a resonant frequency of the antenna radiator 202. According to one embodiment, the control unit 104 may store in advance the resonant frequency of the electromagnetic signal of the antenna radiator 202 acquired by using the receiver 102 in a state where the vehicle is not driven and the user does not hold the steering wheel, as the reference value. For example, the resonant frequency of the acquired electromagnetic signal may be 800 MHz. In other words, the reference value for the antenna radiator 202 may be 800 MHz. According to another embodiment, the control unit 104 may store in advance the resonant frequency that can be calculated based on the length of the antenna radiator 202, as the reference value. For example, the resonant frequency may be calculated by dividing the velocity of light by the length of the antenna radiator. The length of the antenna radiator may be approximated by the circumference of the steering wheel. For example, when the circumference of the steering wheel is 350 mm, the calculated resonant frequency may be approximately 857 MHz. In other words, the reference value for the antenna radiator 202 may be approximately 857 MHz.

The control unit 104 may set the reference range, based on the reference value. The reference range may be a range of +n % (n is a natural number) of the reference value. For example, when the reference value is 800 MHz and n is 5, the reference range for the antenna radiator 202 may be 760 MHz to 840 MHz.

The control unit 104 may calculate the score, based on the resonant frequency of the electromagnetic signal of the antenna radiator 202 acquired by using the receiver 102 in a state where the vehicle is driven. The electromagnetic signal may be measured at a regular time interval by using the receiver 102. The control unit 104 may increase the score by a predetermined size when the resonant frequency of the electromagnetic signal measured at a specific time period falls within a reference range. For example, the control unit 104 may increase the score by 1 when the reference range is 760 MHz to 840 MHz and the resonant frequency confirmed based on the measured signal is 770 MHz.

TABLE 1

| | | |
|---|---|---|
| Reference Value | 800 | MHz |
| Reference Range | 760 to 840 | MHz |

TABLE 2

| Time Period | Resonant Frequency | Score |
|---|---|---|
| 0 | | 0 |
| 1 | 910 MHz | 0 |
| 2 | 780 MHz | 1 |
| 3 | 820 MHz | 2 |
| 4 | 875 MHz | 2 |
| 5 | 800 MHz | 3 |

Table 1 and Table 2 are tables for describing a process in which the scores are calculated for a plurality of time periods.

Referring to Table 1, the reference value may be stored in advance as 800 MHz. The reference range may be set to 760 MHz to 840 MHz.

Referring to Table 2, the score of the 0th time period may be set to 0. In other words, an initial score may be set to 0.

Referring to FIG. 3A, a graph illustrating the return loss of the electromagnetic signal of one antenna radiator 202 which is measured in a first time period as a function of frequency is illustrated. R represents a resonance point, i.e., the resonant frequency. R may be the resonant frequency of the antenna radiator 202.

Referring to FIG. 3A, R may be 910 MHz. In other words, the resonant frequency of the electromagnetic signal measured in the first time period may be 910 MHz. Because 910 MHz is out of the reference range, the control unit 104 may not increase the score. As a result, the score may be maintained at 0.

The resonant frequency of the electromagnetic signal measured in a second time period may be 780 MHz. Because 780 MHz is within the reference range, the control unit 104 may increase the score by 1. As a result, the score may be increased to 1.

The resonant frequency of the electromagnetic signal measured in a third time period may be 820 MHz. Because 820 MHz is within the reference range, the control unit 104 may increase the score by 1. As a result, the score may be increased to 2.

The resonant frequency of the electromagnetic signal measured in a fourth time period may be 875 MHz. Because 875 MHz is out of the reference range, the control unit 104 may not increase the score. As a result, the score may be maintained at 2.

The resonant frequency of the electromagnetic signal measured in a fifth time period may be 800 MHz. Because 800 MHz is within the reference range, the control unit 104 may increase the score by 1. As a result, the score may be increased to 3.

The control unit 104 may determine the hands-off state when the score is equal to or greater than a threshold value. For example, the control unit 104 may determine that the steering wheel is in the hands-off state when the threshold value is set to 3 and the score is calculated as 3 as illustrated in Table 1. In other words, the control unit 104 may determine that the user does not hold the steering wheel with his or her hands.

In this way, in the present disclosure, the antenna radiator is disposed along the circumference of the steering wheel, and the hands on/off state is determined, based on the signal received from the antenna radiator. Accordingly, the hands on/off state may be more precisely determined, compared to the technique for determining the hands on/off state, based on the capacitive sensor. The reason is that a subtle contact or change of the hand may be more precisely measured.

In this way, in the present disclosure, the antenna radiator is disposed along the circumference of the steering wheel, and the hands on/off state is determined, based on the signal received from the antenna radiator. Accordingly, the hands-on/off state may be more accurately determined during straight driving, compared to the technique for determining the hands on/off state, based on the torque sensor.

FIG. 3B is a diagram for describing a graph illustrating signals measured by one or more antenna radiators according to one embodiment of the present disclosure.

The graph illustrated in FIG. 3B may be basically the same graph as the graph illustrated in FIG. 3A except that the number of antenna radiators is different. The graph illustrated in FIG. 3A may be a graph acquired when one antenna radiator 202 is disposed inside the steering wheel 200, and the graph illustrated in FIG. 3B may be a graph acquired when a plurality of antenna radiators 202a, 202b, and 202c are disposed inside the steering wheel 200. The x-axis of the graph represents the frequency. The y-axis of the graph represents the return loss. In other words, the graph may be a plot that represents the return loss of the electromagnetic signal, as the function of the frequency.

When the plurality of antenna radiators are provided, the score may be separately calculated for each antenna radiator, and the reference range may be differently set for each of the antenna radiators. The control unit 104 may store a plurality of reference values in advance for each of the plurality of antenna radiators 202a, 202b, and 202c. The reference value may be inversely proportional to the length of the antenna radiator. In other words, as the length of the antenna radiator is shorter, the reference value may increase. For example, the reference value for the shortest antenna radiator 202a may be 1,300 MHz, the reference value for the second shortest antenna radiator 202b may be 1,100 MHz, and the reference value for the longest antenna radiator 202c may be 800 MHz.

The control unit 104 may set a plurality of reference ranges for each of the plurality of antenna radiators 202a, 202b, and 202c, based on the plurality of reference values. The reference range may be a range of +n % (n is a natural number) of the reference value. For example, when n is 5, the reference range for the antenna radiator 202a may be 1,235 MHz to 1,365 MHz, the reference range for the antenna radiator 202b may be 1,045 MHz to 1,055 MHz, and the reference range for the antenna radiator 202c may be 760 MHz to 840 MHz.

The control unit 104 may calculate the score for each of the plurality of antenna radiators 202a, 202b, and 202c, based on the resonant frequency of the electromagnetic signal of each of the plurality of antenna radiators 202a, 202b, and 202c, which is acquired by using the receiver 102 in a state where the vehicle is driven. The score for each of the plurality of antenna radiators 202a, 202b, and 202c may be calculated by using the basically same method as the method for calculating the score for the antenna radiator 202. In other words, when the plurality of antenna radiators is provided, there is only a difference in that the score is calculated individually for each of the antenna radiators, and the basic calculation method is the same as that when one antenna radiator is provided.

For example, referring to FIG. 3B, a graph is illustrating the return loss of the signal collected from electromagnetic signals of each of the plurality of antenna radiators 202a, 202b and, 202c, which are measured in the first time period, as the function of the frequency. R1, R2, and R3 represent resonance points, i.e., resonant frequencies. R1 may represent the resonant frequency of the antenna radiator 202c, R2 may represent the resonant frequency of the antenna radiator 202b, and R3 may represent the resonant frequency of the antenna radiator 202a.

Referring to FIG. 3B, R1 may be 710 MHz. The reference range for the antenna radiator 202c may be 760 MHz to 840 MHz. Because 710 MHz is out of the reference range, the control unit 104 may not increase the score set for the antenna radiator 202c.

Referring to FIG. 3B, R2 may be 1,030 MHz. The reference range for the antenna radiator 202b may be 1,045 MHz to 1,055 MHz. Because 1,030 MHz is out of the reference range, the control unit 104 may not increase the score set for the antenna radiator 202b.

Referring to FIG. 3B, R3 may be 1,320 MHz. The reference range for the antenna radiator 202a may be 1,235 MHz to 1,365 MHz. Because 1,320 MHz is within the reference range, the control unit 104 may increase the score set for the antenna radiator 202a by 1.

The control unit 104 may determine the hands-off state when the score is equal to or greater than a threshold value. When the plurality of antenna radiators is provided, the control unit 104 may determine whether the score for each antenna radiator is equal to greater than the threshold value, and the control unit 104 may determine a section in which the antenna radiator having the score equal to or greater than the threshold value is disposed, as the hands off state. In other words, when the score for one antenna radiator disposed in a partial section of the steering wheel is equal to or greater than the threshold value, the control unit 104 may determine the partial section, as the hands off state. For example, the control unit 104 may determine whether the score calculated for each of the plurality of antenna radiators 202a, 202b, and 202c is equal to or greater than the threshold value, and the control unit 104 may determine the partial section of the steering wheel in which the antenna radiator having the score equal to or greater than the threshold value is disposed, as the hands off state. For example, the control unit 104 may determine the section in which the antenna radiator 202a is placed, as the hands off state when the threshold value is set to 1 and the scores for the antenna radiator 202a, the antenna radiator 202b, and the antenna radiator 202c are respectively 1, 0, and 0. In other words, the control unit 104 may determine that the user does not hold the section where the antenna radiator 202a is placed in the entire section of the steering wheel with his or her hands.

In this way, in the present disclosure, one or more antenna radiators are disposed along the circumference of the steering wheel. Based on the score calculated for each antenna radiator, the hands off state in the section in which each antenna radiator is disposed is determined. In this manner, the hands on/off state may be determined for each section of the steering wheel. Furthermore, whether the user holds the steering wheel with his or her left or right hand may also be determined. As a result, the hands on/off state may be more precisely determined, compared to the related art.

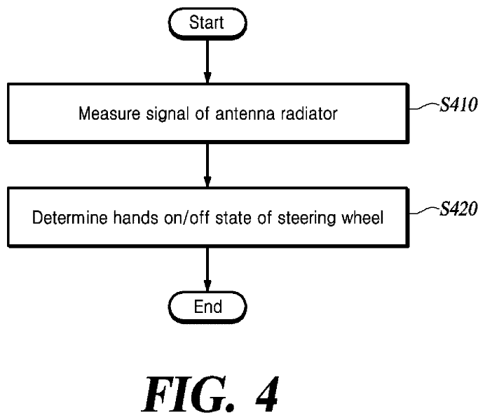

FIG. 4 is a flowchart schematically illustrating a method for hands on/off detection based on an antenna radiator according to one embodiment of the present disclosure.

Referring to FIG. 4, the receiver may measure a signal from one or more antenna radiators disposed inside the steering wheel (S410).

The control unit may determine the hands on/off state of the steering wheel, based on the score determined based on the measured signal (S420).

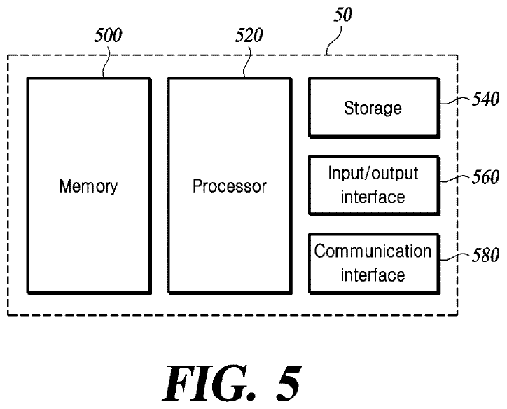

FIG. 5 is a block diagram schematically illustrating a computing device, which may be used to implement an apparatus and a method described in the present disclosure.

The computing device 50 may include all or some of a memory 500, a processor 520, a storage 540, an input/output interface 560, and a communication interface 580. The computing device 50 may be a stationary computing device, such as a desktop computer or a server, or a mobile computing device, such as a laptop computer or a smart phone. The computing device 50 may include a specialized hardware accelerator capable of processing operations of an artificial intelligence model in an efficient manner. For example, the computing device 50 may include a graphic processing unit (GPU), a tensor processing unit (TPU), or a neural processing unit (NPU).

The memory 500 may store a program that enables the processor 520 to perform methods or operations according to various embodiments of the present disclosure. For example, a program may include a plurality of instructions executable by the processor 520, and the methods or operations described above may be performed by executing the plurality of instructions by the processor 520. The memory 500 may comprise a single memory or a plurality of memories. In this case, information required to perform the methods or operation according to various embodiments of the present disclosure may be stored in a single memory or distributed across a plurality of memories. When the memory 500 comprises a plurality of memories, the plurality of memories may be physically separated. The memory 500 may include at least one of volatile memory or non-volatile memory. Volatile memory includes Static Random Access Memory (SRAM) or Dynamic Random Access Memory (DRAM), while non-volatile memory includes flash memory.

The processor 520 may include at least one core capable of executing at least one instruction. The processor 520 may execute instructions stored in the memory 500. The processor 520 may comprise a single processor or a plurality of processors.

The storage 540 maintains stored data even if power supplied to the computing device 50 is cut off. For example, the storage 540 may include non-volatile memory or may include a storage medium such as a magnetic tape, an optical disk, or a magnetic disk. A program stored in the storage 540 may be loaded into the memory 500 before being executed by the processor 520. The storage 540 may store files written in a program language, and a program created from the files by a compiler may be loaded into the memory 500. The storage 540 may store data to be processed by the processor 520 and/or data processed by the processor 520.

The input/output interface 560 may provide an interface with an input device such as a keyboard or a mouse and/or an output device such as a display device or a printer. The user may trigger execution of a program by the processor 520 through the input device and/or check the processing results of the processor 520 through the output device.

The communication interface 580 may provide access to an external network. The computing device 50 may communicate with other devices through the communication interface 580.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium, such as a read-only memory (ROM), a random access memory (RAM), a compact disc ROM (CD-ROM), magnetic tape, a floppy disk, or an optical data storage device. In addition, the computer-readable recording medium may further include a transitory medium, such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, one of ordinary skill in the art should understand that the scope of the present disclosure should not limited by the above explicitly described embodiments but by the claims and equivalents thereof.

What is claimed is:

1. A method for detecting a hands on/off state of a steering wheel of a vehicle, the method comprising:
measuring a signal from one or more antenna radiators disposed inside the steering wheel of the vehicle; and
determining the hands on/off state of the steering wheel, based on a score determined based on the signal.

2. The method of claim 1, wherein the signal is a return loss signal, and the score is increased by a predetermined size when a resonant frequency of the signal falls within a reference range.

3. The method of claim 1, wherein determining the hands on/off state of the steering wheel based on the score includes determining a hands off state when the score is equal to or greater than a threshold value.

4. The method of claim 1, wherein the one or more antenna radiators are disposed over a plurality of sections along a circumference of the steering wheel.

5. The method of claim 1, wherein scores are separately calculated for each of the one or more antenna radiators, and the number of the scores is the same as the number of the antenna radiators.

6. The method of claim 2, wherein the reference range is differently set for each of the one or more antenna radiators, and the number of the reference ranges is the same as the number of the antenna radiators.

7. The method of claim 4, wherein determining the hands on/off state of the steering wheel based on the score includes determining a partial section of the steering wheel as a hands off state, when the score for one antenna radiator disposed in the partial section of the steering wheel is equal to or greater than a threshold value.

8. An apparatus for detecting a hands on/off state of a steering wheel of a vehicle, the apparatus comprising:
one or more antenna radiators disposed inside the steering wheel of the vehicle;
a receiver configured to detect a change in the one or more antenna radiators; and
a control unit configured to determine the hands on/off state of the steering wheel, based on a signal measured using the receiver.

9. The apparatus of claim 8, wherein the one or more antenna radiators are a loop antenna type made of a conductive material.

10. The apparatus of claim 8, wherein the one or more antenna radiators are disposed over a plurality of sections along a circumference of the steering wheel.

11. The apparatus of claim 8, wherein the one or more antenna radiators each have a different size.

12. The apparatus of claim 8, wherein the control unit includes:
at least one memory configured to store commands; and
at least one processor configured, by executing the commands, to determine the hands on/off state of the steering wheel, based on a score determined based on the signal.

13. The apparatus of claim 12, wherein the signal is a return loss signal, and the score increases by a predetermined size when a resonant frequency of the signal falls within a reference range.

14. The apparatus of claim 12, wherein the at least one processor is configured to determine the hands on/off state of the steering wheel based on the score by determining a hands off state when the score is equal to or greater than a threshold value.

15. The apparatus of claim 12, wherein the one or more antenna radiators are disposed over a plurality of sections along a circumference of the steering wheel.

16. The apparatus of claim 12, wherein scores are separately calculated for each of the one or more antenna radiators, and the number of the scores is the same as the number of the antenna radiators.

17. The apparatus of claim 13, wherein the reference range is differently set for each of the one or more antenna radiators, and the number of the reference ranges is the same as the number of the antenna radiators.

18. The apparatus of claim 15, wherein the at least one processor is configured to determine the hands on/off state of the steering wheel based on the score by determining a partial section of the steering wheel as a hands off state, when the score for one antenna radiator disposed in the partial section of the steering wheel is equal to or greater than a threshold value.
